(19) United States
(12) Patent Application Publication
(10) Pub. No.: US 2001/0035921 A1
(43) Pub. Date: Nov. 1, 2001

(54) Method for mounting display panel used in information processing apparatus and display panel housing therefor

(76) Inventor: Masahiko Yamanami, Niigata (JP)

Correspondence Address: Paul J. Esatto, Jr., Scully, Scott, Murphy & Presser, 400 Garden City Plaza, Garden City, NY, 11530, US

(21) Appl. No.: 09/843,008

(22) Filed: Apr. 26, 2001

(30) Foreign Application Priority Data
Apr. 26, 2000 (JP) 125460/2000

(51) Int. Cl. G02F 1/1333

(52) U.S. Cl. 349/58

(57) ABSTRACT

There is provided a mounting method of a display panel of a number of kinds which is different in one or all of shape, thickness, size, or like, installed in an information processing apparatus such as a notebook personal computer, on a common display panel housing. It is possible to employ and mount various kinds of display panels without changing the display panel housing by means of using a common panel-mounting case, a common display cover, and a combination of first spacers, second spacers, and holding members.

### BACKGROUND OF THE INVENTION

1. Field of the Invention

the present invention relates to a method for mounting display panel used in information processing apparatus and display panel housing therefor and a display panel housing of the same, and more particularly to a method for mounting a display panel selected from various kinds of display panels in a predetermined common display panel housing installed in an open-and-close manner or detachably on a main body of an information processing apparatus such as a notebook personal computer or a like, and the display panel housing.

The present application claims priority of Japanese Patent Application No. 2000-125460 filed on Apr. 26, 2000, which is hereby incorporated by reference.

2. Description of the Related Art

Recently, in general, a liquid crystal display portion of an open-and-close type is installed on a main body of an information processing apparatus such as a notebook personal computer or a like which has been rapidly popularized.

The liquid crystal display portion is manufactured as an integral structure body of a display panel housing, that is a display cover plate of a visual field is used or functions as a cover lid on the display panel installed in an panel-mounting case.

However, there are many occasions in which the liquid crystal display portion changes in a display picture size of the display panel, a display resolution, or a thickness and a shape of the display panel.

Therefore, it has been necessary, in such occasions, to change the whole structure of the display panel housing. Practically, the expensive display panel housing has been unavoidably changed and discarded.

As described above, a display picture size of the display panel, display resolution, or a thickness and a shape of the display portion of many conventional information display portions installed on the main body of the information processing apparatus such as the notebook personal computer or a like so as to open and close, or be detachable have been changed for long period. Ordinarily, it is a general way to exchange a new display panel housing and the information display portion included in the housing with an old one.

In the foregoing, it is preferable economically and effective extraordinarily if the display panels of many kinds can be installed in the identical display panel housing of the same kind decreasing a number of parts to be discarded without changing the whole structure of the panel-mounting cases.

In addition, if it is possible to exchange an old display panel with a new display panel of highest technology at the time and mount the new one without changing the design of the panel-mounting case in order, it will follow to extend a life of the information processing apparatus.

### SUMMARY OF THE INVENTION

In view of the above, it is an object of the present invention to provide a display panel mounting method capable of mounting, with a low cost and with ease and universally, a display panel selected from various kinds of display panels in a predetermined common display panel housing installed in an open-and-close manner or detachably on a main body of an information processing apparatus such as a notebook personal computer or a like, and the display panel housing

According to a first aspect of the present invention, there is provided a method for mounting a display panel selected from various kinds of display panels in a predetermined common display panel housing installed in an open-and-close manner or detachably on a main body of an information processing apparatus, wherein the display panel housing has a predetermined panel-mounting case for inserting the display panel therein and a predetermined panel-edge cover for covering edge portions of the display panel, the method including:

a step of inserting the display panel in the predetermined panel-mounting case through at least one first spacer, whereby the at least one first spacer is placed between a back face of the display panel and an inner main-face of the panel-mounting case;

a step of fixedly holding the display panel in the panel-mounting case with at least two holding members, disposed at different positions each other; and

a step of covering edge portions of the display panel in the panel-mounting case with the predetermined edge-cover;

whereby the display panel is mounted in the predetermined common display panel housing.

In the foregoing first aspect, a preferable mode is one that wherein further includes:

a step of positioning and fixing the display panel along its up-and-down direction panel with at least one second spacer, wherefore the at least one second spacer is provided between a lower inner side face of the panel-mounting case and a lower outer side face of the display panel.

Also, a preferable mode is one wherein the various kinds of display panels are different from each other in any one of shape, thickness, picture quality, and display screen size.

Also, a preferable mode is one wherein the at least two holding members, the at least one first spacer and the at least one second spacer are used in combination in accordance with each of the various kinds of display panels.

Also, a preferable mode is one wherein the holding members are fixed to the panel-mounting case by screw-fixing or fitting.

According to a second aspect of the present invention, there is provided a display panel housing installed in an open-and-close manner or detachably on a main body of an information processing apparatus, mounting a display panel selected from various kinds of display panels, the display panel housing comprising:

a predetermined panel-mounting case for inserting the display panel therein;

a predetermined panel-edge cover for covering edge portions of the display panel;

at least one first spacer sandwiched between a back face of the display panel and an inner main-face of the panel-mounting case, such that the display panel is placed in the predetermined panel-mounting case through at least one first spacer;

at least two holding members disposed at different positions from each other, with which the display panel is fixedly held in the panel-mounting case;

wherein edge portions of the display panel are covered in the panel-mounting case with the predetermined panel-edge cover; and

whereby the display panel is mounted in the predetermined common display panel housing.

In the foregoing second aspect, a preferable mode is one that wherein further including:

at least one second spacer for positioning and fixing the display panel along its up-and-down direction panel, wherefore the at least one second spacer is provided between a lower inner side face of the panel-mounting case and a lower outer side face of the display panel.

Also, a preferable mode is one wherein the various kinds of display panels are different from each other in any one of shape, thickness, picture quality, and display screen size.

Also, a preferable mode is one wherein the at least two holding members, the at least one first spacer and the at least one second spacer are used in combination in accordance with each of the various kinds of display panels.

With the above configurations, it is possible to employ and mount various display panels different in one or all of shape, thickness, size, and display resolution without changing the display panel housing. This can be accomplished by means of using a common panel-mounting case and a common display cover of the display panel housing and some spacers of a shape of simple manufacture.

Concerning a change of the display panel size, the display cover can be changed so as to be suitable to the particular display panel size by means of change of necessary parts of a minimum number.

Also, it is possible to decrease extraordinary deformation stresses created in a structure of the display panel even though the panel-mounting case and the display cover bend or deform because that the display panel is not directly screw-fixed or bond-fixed.

In case that the display panel must be changed to another one, it is not needed to change as the conventional way does the display panel housing, thus enabling to decrease a volume of parts to be discarded or wasted.

### BRIEF DESCRIPTION OF THE DRAWINGS

The above and other objects, advantages, and features of the present invention will be more apparent from the following description taken in conjunction with the accompanying drawings in which:

FIG. 1 is a perspective view for showing an information processing apparatus (notebook personal computer) with a display cover of a display panel housing removed, according to an embodiment of the present invention, and

FIG. 2 is an exploded perspective view of the display panel according to an embodiment of the present invention.

### DETAILED DESCRIPTION OF THE PREFERRED EMBODIMENT

Best mode of carrying out the present invention will be described in further detail using a preferable embodiment with reference to the accompanying drawings.

### EMBODIMENT

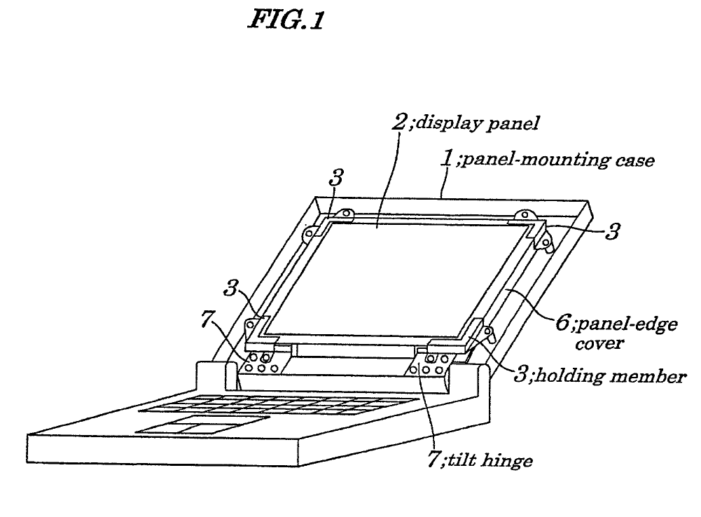

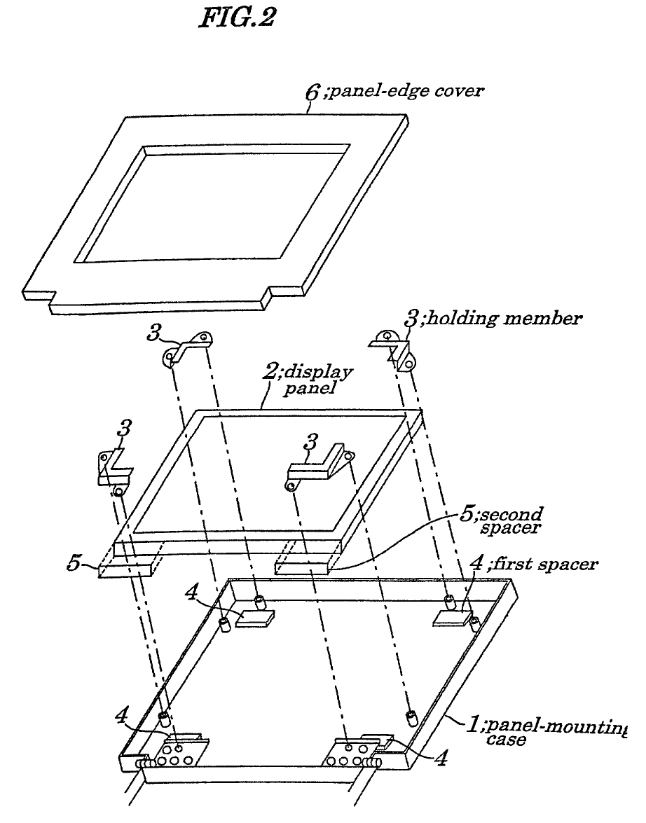

FIG. 1 and FIG. 2 show a notebook personal computer as an information processing apparatus, according to an embodiment of the present invention.

The display panel housing according to the embodiment, as shown in FIG. 1, is installed in an open-and-close on a main body of a notebook personal computer.

In a display panel housing, as shown in the same figure, a particular display panel 2 is mounted in a predetermined common panel-mounting case 1. For example, as shown in FIG. 1, the display panel 2 is fixed in the panel-mounting case 1 by screws and holding members 3 placed at four corners of the display panel 2.

As shown in FIG. 2, first spacers 4 placed near four corners of the panel-mounting case 1 and on an inner main-face of the panel-mounting case 1, and second spacers 5 placed between an inner main-face of the panel-mounting case 1 and a side face of the display panel 2, which side faces are positioned at their lower positions when the display panel 2 is open as shown in FIG. 1. Accordingly, the first spacers 4 support a rear face of the display panel 2 and the second spacers 5 prevent the display panel 2 from shifting along an up-and-down direction while the display panel 2 is erected.

Furthermore, in particular, the second spacers 5 are placed between the display panel 2 and tilt hinges 7 when the display panel 2 is open, so that the second spacers 5 prevent effectively the display panel 2 from shifting due to outside shocks.

After the display panel 2 moved in the panel-mounting case 1 in a manner as described above, the holding members 3 are placed at four corners of the display panel 2 so as to fit on these corners of the display panel 2, and then these holding members 3 are fixed in place by a number of screws. Then a display cover 6 is applied to and covers the panel-mounting case 1 so as to be detachable by means of suitable means.

The second spacers 5 are placed between a lower inner side face of the panel-mounting case 1 and a lower outer side face of the display panel 2 when the open type display panel housing is erected. The second spacers 5 function as a set of members fixing and placing the display panel 2 preventing the display panel 2 from sliding along up-and-down direction while the display panel housing is open.

Consequently, even if the display panels 2 are different from each other or of various kinds as described above, and the panel-mounting case 1 and the display cover 6, respectively of the display panel housing are of a common predetermined type, the display panels 2 can be mounted as one integral structure in the panel-mounting case 1 simply, and it is not necessary to change the panel-mounting case 1 and the display cover 6 of high cost by using various combinations of the first spacers 4, the second spacers 5 and the holding members 3.

It is apparent that the present invention is not limited to the above embodiment but may be changed and modified without departing from the scope and spirit of the invention. For example, it is also possible to employ any suitable means instead of the holding members 3, for example, a fitting-type (not shown), other than the screw-type, in order to fix the display panel 2 in the panel-mounting case 1.

Also, a display panel housing may be installed detachably in instead of an open-and-close manner on a main body of an information processing apparatus.

It is also possible to use other different means for holding and fixing the display panel 2, other than the holding members 3, pressing both side faces or upper and bottom faces of the open display panel 2. Fixing the display panel 2 through its two corners on a diagonal line of the panel 2 is suitable way.

As described above, with the above embodiment of the present invention, it is possible to employ and mount various display panels different in one or all of shape, thickness, size, and display resolution without changing the display panel housing by means of using a common panel-mounting case and a common display cover of the display panel housing and some spacers of a shape of simple manufacturing.

Concerning a change of the display panel size, the display cover can be changed so as to be suitable to the particular display panel size by means of a change of necessary parts of minimum number.

Also, it is possible to decrease extraordinary deformation stresses created in a structure of the display panel even though the panel-mounting case and the display cover bend or deform because that the display panel is not directly screw-fixed or bond-fixed.

In case that the display panel must be changed to another one, it is not needed to change as the conventional way does the display panel housing, thus enabling to decrease a volume of parts to be discarded or wasted.

What is claimed is:

1. A method for mounting a display panel selected from various kinds of display panels in a predetermined common display panel housing installed in an open-and-close manner or detachably on a main body of an information processing apparatus, wherein said display panel housing has a predetermined panel-mounting case for inserting said display panel therein and a predetermined panel-edge cover for covering edge portions of said display panel, said method comprising:
a step of inserting said display panel in said predetermined panel-mounting case through at least one first spacer, whereby said at least one first spacer is sandwiched between a back face of said display panel and an inner main-face of said panel-mounting case;
a step of fixedly holding said display panel in said panel-mounting case with at least two holding members, disposed at different positions from each other; and
a step of covering edge portions of said display panel in said panel-mounting case with said predetermined panel-edge cover; and
whereby said display panel is mounted in said predetermined common display panel housing.

2. The mounting method according to claim 1, further comprising:
a step of positioning and fixing said display panel along its up-and-down direction panel with at least one second spacer, wherefore said at least one second spacer is provided between a lower inner side face of said panel-mounting case and a lower outer side face of said display panel.

3. The mounting method according to claim 1, wherein said various kinds of display panels are different from each other in any one of shape, thickness, picture quality, and display screen size.

4. The mounting method according to claim 1, wherein said at least two holding members, said at least one first spacer and said at least one second spacer are used in combination in accordance with each of said various kinds of display panels.

5. The mounting method according to claim 1, wherein said at least two holding members are fixed to said panel-mounting case by screw-fixing or fitting.

6. A display panel housing installed in an open-and-close manner or detachably on a main body of an information processing apparatus, mounting a display panel selected from various kinds of display panels, said display panel housing comprising:
a predetermined panel-mounting case for inserting said display panel therein;
a predetermined panel-edge cover for covering edge portions of said display panel;
at least one first spacer sandwiched between a back face of said display panel and an inner main-face of said panel-mounting case, such that said display panel is placed in said predetermined panel-mounting case through at least one first spacer;
at least two holding members disposed at different positions from each other, with which said display panel is fixedly held in said panel-mounting case;
wherein edge portions of said display panel are covered in said panel-mounting case with said predetermined panel-edge cover; and
whereby said display panel is mounted in said predetermined common display panel housing.

7. The display panel housing according to claim 6, further comprising:
at least one second spacer for positioning and fixing said display panel along its up-and-down direction panel, wherefore said at least one second spacer is provided between a lower inner side face of said panel-mounting case and a lower outer side face of said display panel.

8. The display panel housing according to claim 6, wherein said various kinds of display panels are different from each other in any one of shape, thickness, picture quality, and display screen size.

9. The display panel housing according to claim 6, wherein said at least two holding members, said at least one first spacer and said at least one second spacer are used in combination in accordance with each of said various kinds of display panels.

10. The display panel housing according to claim 6, wherein said at least two holding members are fixed to said panel-mounting case by screw-fixing or fitting.
